(19) United States
(12) Patent Application Publication
(10) Pub. No.: US 2025/0298276 A1
(43) Pub. Date: Sep. 25, 2025

(54) DISPLAY DEVICE

(71) Applicant: Japan Display Inc., Tokyo (JP)

(72) Inventors: Shunichi KIMURA, Tokyo (JP); Toshiharu MATSUSHIMA, Tokyo (JP); Yuji MAEDE, Tokyo (JP)

(21) Appl. No.: 19/082,367

(22) Filed: Mar. 18, 2025

(30) Foreign Application Priority Data
Mar. 22, 2024 (JP) 2024-046685

(51) Int. Cl. G02F 1/1343; G02F 1/1335; G02F 1/1337

(52) U.S. Cl. CPC G02F 1/134318; G02F 1/133512; G02F 1/133707

(57) ABSTRACT

According to one embodiment, a display device includes a plurality of scanning lines, a plurality of signal lines, a plurality of pixels, and a common electrode, wherein the plurality of pixels have a shape of a square, which has a same length along the first direction and the second direction, a trunk portion extends along the first direction, each of a plurality of branch portions extends from the trunk portion along the second direction, a part of the signal lines extends along the first direction, of the plurality of branch portions, those located close to the signal lines are shielded by a light shielding region, which is the part of the signal lines, and the plurality of pixels are driven by a field sequential method.

### CROSS-REFERENCE TO RELATED APPLICATIONS

This application is based upon and claims the benefit of priority from Japanese Patent Application No. 2024-046685, filed Mar. 22, 2024, the entire contents of which are incorporated herein by reference.

### FIELD

Embodiments described herein relate generally to a display device.

### BACKGROUND

As an example of the display device, an in-plane switching (IPS) mode liquid crystal display is known. In an IPS mode liquid crystal display, a pixel electrode and a common electrode are provided on one of a pair of substrates opposing each other through a liquid crystal layer, and the alignment of liquid crystal molecules in the liquid crystal layer is controlled using a transverse electric field generated between these electrodes. Further, in the IPS mode, liquid crystal display devices of a fringe field switching (FFS) mode, in which the pixel electrode and the common electrode are arranged in different layers, have been put into practical use. In such a liquid crystal display device, the alignment of the liquid crystal molecules is controlled using a fringe field generated between the pair of electrodes.

### BRIEF DESCRIPTION OF THE DRAWINGS

FIG. 1 is a diagram showing an example of the equivalent circuit of a display device.

FIG. 2 is a cross-sectional view showing a configuration example of the display device.

FIG. 3 is a plan view showing an arrangement of pixels of a display device in a comparative example.

FIG. 4 is a plan view showing a configuration of a pixel of the comparative example.

FIG. 5 is a plan view showing a relationship between a slit and liquid crystal molecules of positive liquid crystal.

FIG. 6 is a plan view showing a relationship between a slit and liquid crystal molecules of negative liquid crystal.

FIG. 7 is a diagram showing a relationship between branch portions of the slit and transmission of light in the comparative example.

FIG. 8 is a diagram showing a relationship between branch portions of the slit and transmission of light in the comparative example.

FIG. 9 is a plan view showing a configuration of a pixel of the embodiment.

FIG. 10 is a plan view showing a pixel electrode and a common electrode of the pixel.

FIG. 11 is a cross-sectional view showing a cross-sectional configuration of the pixel taken along line A1-A2 shown in FIG. 10.

FIG. 12 is a diagram showing a response speed of the pixel to applied voltage.

### DETAILED DESCRIPTION

In general, according to one embodiment, a display device comprises
a plurality of scanning lines extending along a first direction;
a plurality of signal lines extending along a second direction intersecting the first direction;
a plurality of pixels each provided at each respective one of intersections between the plurality of signal lines and the plurality of scanning lines; and
a common electrode including a slit including a trunk portion and a plurality of branch portions,
wherein
the plurality of pixels have a shape of a square, which has a same length along the first direction and the second direction,
the trunk portion extends along the first direction,
each of the plurality of branch portions extends from the trunk portion along the second direction,
a part of the signal lines extends along the first direction,
of the plurality of branch portions, those located close to the signal lines are shielded by a light shielding region, which is the part of the signal lines, and
the plurality of pixels are driven by a field sequential method.

An object of this embodiment is to provide a display device with high response speed and brightness.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment 1

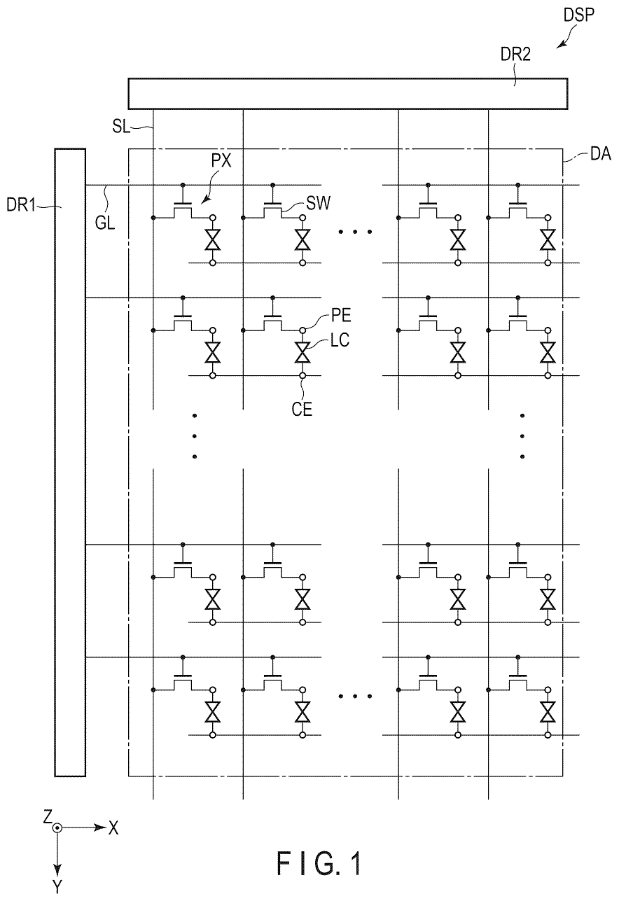

FIG. 1 is a diagram showing an example of an equivalent circuit of a display device.

A display device DSP comprises a plurality of pixels PX, a plurality of scanning lines GL, and a plurality of signal lines SL in a display area DA, which displays images. The plurality of scanning lines GL and the plurality of signal lines SL intersect each other. Further, the display device DSP comprises a driver DR1 and a driver DR2 on an outer side of the display area DA. The plurality of scanning lines GL are electrically connected to the driver DR1. The plurality of signal lines SL are electrically connected to the driver DR2. The drivers DR1 and DR2 are controlled by a control device.

The pixels PX shown here are referred to as subpixels or color pixels, and correspond to pixels that display, for example, red, green, blue, and white, respectively. The pixels PX are each provided at an intersection between the respective one of the scanning lines GL and the respective one of the signal lines SL. Further, the pixels PX are each compartmentalized by the respective adjacent pair of scanning lines GL and the respective adjacent pair of signal lines SL.

The pixels PX each comprise a switching element SW, a pixel electrode PE, and a common electrode CE opposing the pixel electrodes PE. The switching element SW is electrically connected to the respective scanning line GL and the respective signal line SL. The pixel electrode PE is electrically connected to the respective switching element SW. That is, the pixel electrode PE is electrically connected to the respective signal line SL via the respective switching element SW. The common electrode CE is formed over a plurality of pixels PX. To the common electrode CE, a common potential is applied.

The driver DR1 supplies a scanning signal to each of the scanning lines GL. The driver DR2 supplies a video signal to each of the signal lines SL. In the switching element SW electrically connected to the respective scanning line GL to which the scanning signal is supplied, the signal line SL and the pixel electrode PE are connected, and a voltage corresponding to the video signal supplied to the signal line SL is applied to the pixel electrode PE. The liquid crystal layer LC is driven by the electric field that is generated between the respective pixel electrode PE and the common electrode CE. In more detail, the alignment of the liquid crystal molecules in the liquid crystal layer LC changes from the initial alignment state in which no voltage is being applied due to the electric field generated between the pixel electrode PE and the common electrode CE. By such an operation, images are displayed on the display area DA.

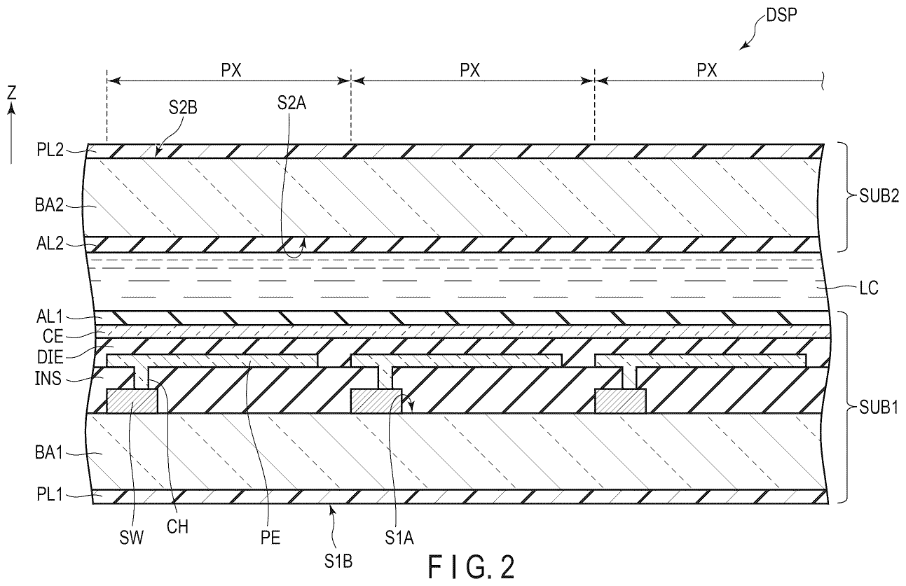

FIG. 2 is a cross-sectional view showing a configuration example of the display device.

The display device DSP comprises a substrate SUB1, a substrate SUB2, and a liquid crystal layer LC held between the substrate SUB1 and the substrate SUB2.

The substrate SUB1 comprises, in addition to the switching elements SW, pixel electrodes PE, and common electrode CE, a base BA1, an insulating layer INS, an insulating layer DIE, and an alignment film AL1. Further, the substrate SUB1 comprises the scanning lines GL, signal lines SL, drivers DR1 and DR2, and the like, shown in FIG. 1. The base BA1 is formed from a glass base material or resin base material that has transparency to light. The base BA1 has a main surface S1A opposing the substrate SUB2 and a main surface S1B on the opposite side to the main surface S1A.

The switching elements SW are formed on a main surface S1A side of the base BA1 and are covered by the insulating layer INS. In the example shown in FIG. 2, the switching element SW is illustrated in a simplified form for the sake of convenience in explanation of the embodiment, and the scanning lines GL and signal lines SL are omitted from the illustration. In practice, the insulating layer INS may include a plurality of insulating layers. The switching elements SW includes semiconductor layers and various electrodes formed in these layers.

The pixel electrodes PE are formed on the insulating layer INS and are provided the plurality of pixels PX, respectively. The pixel electrodes PE are covered by the insulating layer DIE. The common electrode CE is provided over the plurality of pixels PX. The common electrode CE is formed on the insulating layer DIE so as to oppose the pixel electrodes PE via the insulating layer DIE.

The pixel electrodes PE are each electrically connected to the respective switching element SW via a respective contact hole CH, which penetrates the insulating layer INS. The pixel electrodes PE and the common electrode CE are transparent electrodes formed of, for example, a transparent conductive material such as indium tin oxide (ITO) or indium zinc oxide (IZO).

The alignment film AL1 covers the common electrode and is in contact with the liquid crystal layer LC. The alignment film AL1 is, for example, an optical alignment film that has been subjected to photo-alignment treatment.

The substrate SUB2 comprises a base BA2 and an alignment film AL2. The base BA2 is formed from a glass base material or a resin base material that has light transmissivity. The base BA2 has a main surface S2A opposing the substrate SUB1 and a main surface S2B on an opposite side to the main surface S2A.

The alignment film AL2 is provided in contact with the base BA2 so as to be in contact with the liquid crystal layer LC. The alignment film AL2 is an optical alignment film that has been subjected to photo-alignment treatment, as is the case of the alignment film AL1.

Between the alignment film AL2 and the base BA2, a light-shielding layer and the like may as well be provided so as to oppose the insulating layer and the switching elements SW.

To the main surface S1B of the base BA1, a polarizer PL1 is adhered, and to the main surface S2B of the base BA2, a polarizer PL2 is adhered.

The display device DSP is driven by a field sequential method, which controls the pixels so that a plurality of colors of light are transmitted from the same pixel at different timings, respectively. For example, a single frame period includes a plurality of subframe (field) periods, and in each subframe period, red, green, and blue pixels are selectively displayed. The pixels of the colors displayed by this time-sharing manner are combined together, and thus the user can see images of multi-color display.

In display devices DSP to be driven by the field sequential method, it is necessary to drive the pixels at high speed. This is because if the pixels are not driven at high speed, flickering of the displayed image and the like may occur, thus deteriorating the display quality.

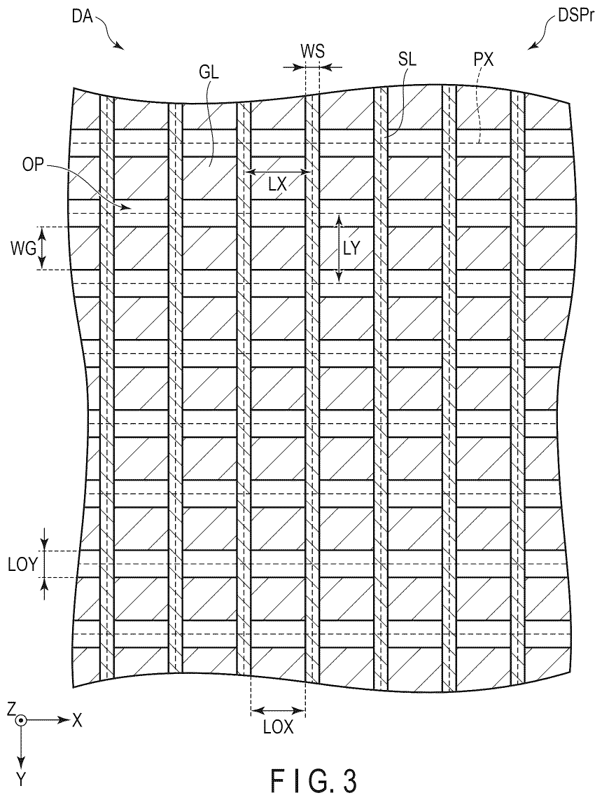

FIG. 3 is a plan view showing the arrangement of the pixels of a display device of a comparative example. FIG. 3 illustrates only the scanning lines GL and signal lines SL to be provided in the display area DA of a display device DSPr of the comparative example.

The plurality of scanning lines GL are extended along the first direction X and aligned along the second direction Y. The plurality of signal lines SL are extended along the second direction Y and aligned along the first direction X. The length (width) along the second direction Y of each of the scanning lines GL is defined as a width WG. The length (width) along the first direction X of each of the signal lines SL is defined as a width WS.

Each of the plurality of pixels PX is provided in a region surrounded by each respective adjacent pair of scanning lines GL and each respective adjacent pair of signal lines SL. In FIG. 3, the pixels PX are indicated by dotted lines. The length of each of the pixels PX along the first direction X is defined as a length LX, and the length of each of the pixels PX along the second direction Y is defined by a length LY. The lengths LX and LY are equivalent to the pitches of the signal lines SL and the scanning lines GL, respectively.

The width WG of the scanning lines GL is greater than the width WS of the signal lines SL. The length LX and length LY of the pixels PX are approximately equal to each other. Therefore, the pixels PX have a square shape.

The length LX and the length LY are, for example, 12.7 μm. The width WG of the scanning lines GL is, for example, 8.0 μm. The width WS of the signal lines SL should be, for example, 2.0 μm or more and 2.5 μm or less.

The region of each pixel PX that does not overlap the scanning line GL and the signal line SL is defined as an aperture region OP. The lengths of the aperture area OP along the first direction X and the second direction Y are defined as a length LOX and a length LOY, respectively. The length LOX should be, for example, 10.2 μm or more and 10.7 μm or less. The length LOY should be 4.7 μm or less.

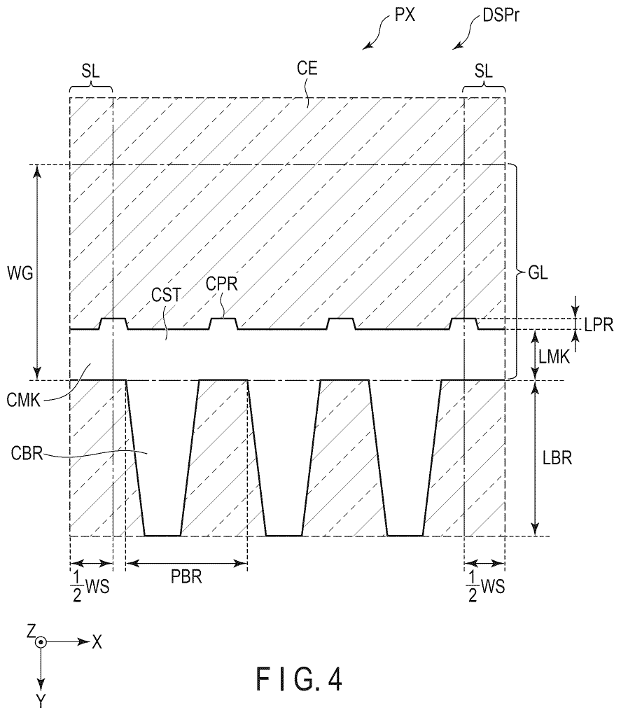

FIG. 4 is a plan view showing the configuration of the pixels of the comparative example. A pixel PX of the display device DSPr shown in FIG. 4 includes two adjacent signal lines SL in half, one scanning line GL, and a common electrode CE. Note that in FIG. 4, the switching element and the pixel electrode are omitted.

The common electrode CE has a slit CST. The slit CST includes a trunk portion CMK that extends along the first direction X, a protrusion portion CPR that protrudes from the trunk portion CMK along a direction opposite to the second direction Y, and a branch portion CBR that extends from the trunk portion CMK along the second direction Y. That is, the extending direction of the protrusion portion CPR and the extending direction of the branch portion CBR are opposite to each other. Each of the plurality of protrusion portions CPR is arranged between each respective pair of branch portions CBR, adjacent to each other along the first direction X.

The protrusion portions CPR have a trapezoidal shape having an upper side shorter than a lower side. Note that the lower side of the protrusion portion CPR is a side of the boundary with the trunk portion CMK. The upper side of the protrusion portion CPR is a side that is separated from the trunk portion CMK.

The branch portions CBR each have a trapezoidal shape having an upper side longer than a lower side. The upper side of the branch portion CBR is the side of the boundary with the trunk portion CMK. The lower side of the trunk portion CMK is the side that is separated from the trunk portion CMK. It can be said that the branch portion CBR has a shape that tapers down toward the tip down below, or the so-called wedge-like shape.

The length (width) of the trunk portion CMK along the second direction Y is defined as a length LMK. The length of the protrusion portion CPR along the second direction Y is defined as a length LPR. The length LMK should be, for example, 0.5 μm or more and 1.5 μm or less, and more specifically, 1.5 μm. The length LPR should be, for example, 0 μm or more and 0.5 μm or less, and more specifically, 0.5 μm.

The length of the branch portion CBR along the second direction Y is defined as a length LBR. The pitch at which the plurality of branch portions CBR are arranged along the first direction X is defined as a pitch PBR. The length LBR should be, for example, 4.0 μm or more and 5.0 μm or less, and more specifically, 4.7 μm. The pitch PBR should be 3.5 μm or more and 4.0 μm or less, and more specifically, 4.0 μm.

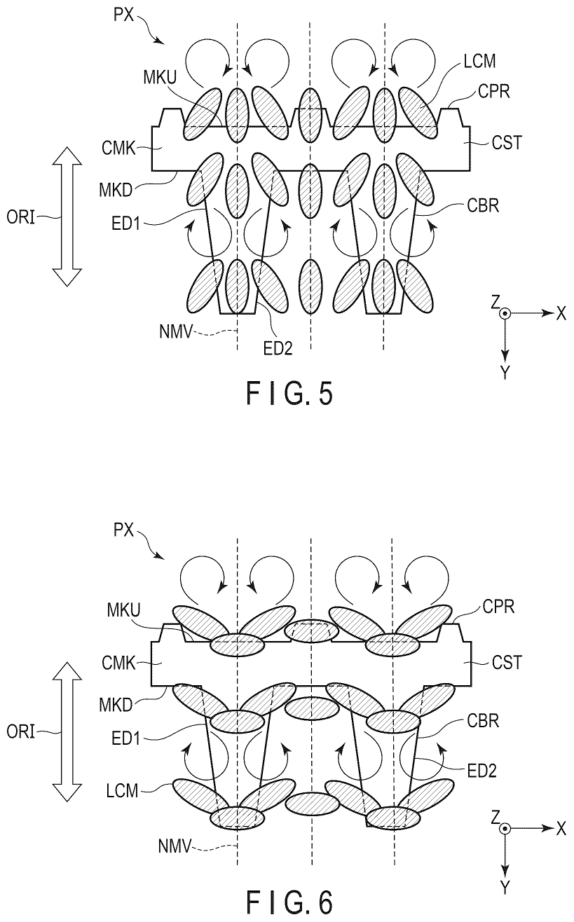

FIG. 5 is a plan view showing the relationship between a slit and the liquid crystal molecules of the positive liquid crystal. FIG. 6 is a plan view showing the relationship between the slit and the liquid crystal molecules of the negative liquid crystal. In FIGS. 5 and 6, the alignment direction of the alignment film AL1 and the alignment film AL2 is defined as an alignment direction ORI. In FIGS. 5 and 6, the alignment direction ORI is a direction parallel to the second direction Y.

The positive liquid crystals are liquid crystals that have positive dielectric anisotropy. The negative liquid crystals are liquid crystals that have negative dielectric anisotropy. The initial alignment direction of the liquid crystal molecules of positive liquid crystals is parallel to the alignment direction ORI, while the initial alignment of the liquid crystal molecules of negative liquid crystals is perpendicular to the alignment direction ORI.

As shown in FIGS. 5 and 6, the side of the slit CST that is on the left side of the page is defined as an edge ED1, and the side of the slit CST on the right side is defined as an edge ED2. In FIG. 5, when a voltage is applied to the common electrode CE, liquid crystal molecules LCM located in the vicinity of the edge ED1 rotate clockwise. The liquid crystal molecules located in the vicinity of the edge ED2 rotate counterclockwise.

The upper edge of the trunk portion CMK of the slit CST is defined as an edge MKU, and the lower edge is defined as an edge MDK. The liquid crystal molecules LCM near the edge MKU and also aligned along the second direction Y with the liquid crystal molecules LCM near the edge ED1 rotate clockwise. The liquid crystal molecules LCM near the edge MKU and also aligned along the second direction Y with the liquid crystal molecules LCM near the edge ED2 rotate counterclockwise.

That is, the liquid crystal molecules LCM that are aligned along the second direction Y with liquid crystal molecules LCM in the vicinity of the edge ED1 rotate clockwise even if they are away from the edge ED1. The liquid crystal molecules LCM that are aligned along the second direction Y with liquid crystal molecules LCM in the vicinity of the edge ED2 rotate counterclockwise even if they are away from the edge ED2.

Even if a voltage is applied to the common electrode CE and an electric field is generated, the liquid crystal molecules LCM located in the center region of the branch portion CBR and the center region of the protrusion portion CPR do not rotate. Such a region that liquid crystal molecules LCM do not rotate there is referred to as a region NMV. In the region NMV, the liquid crystal molecules LCM do not rotate, and therefore light does not pass through and the region becomes dark.

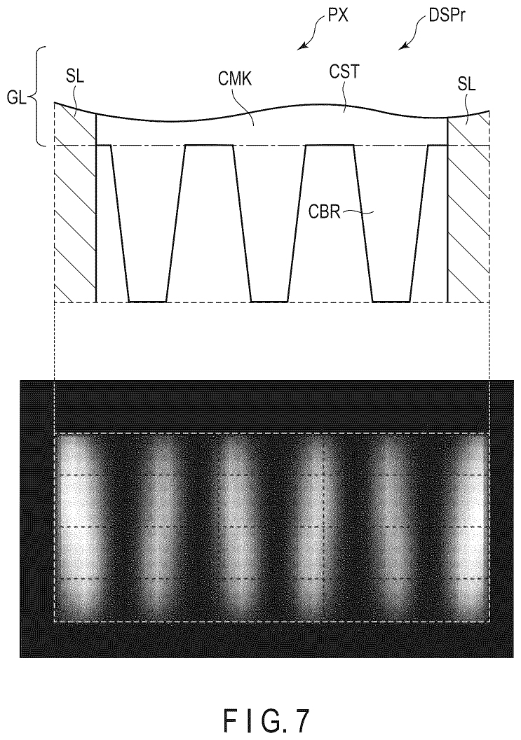

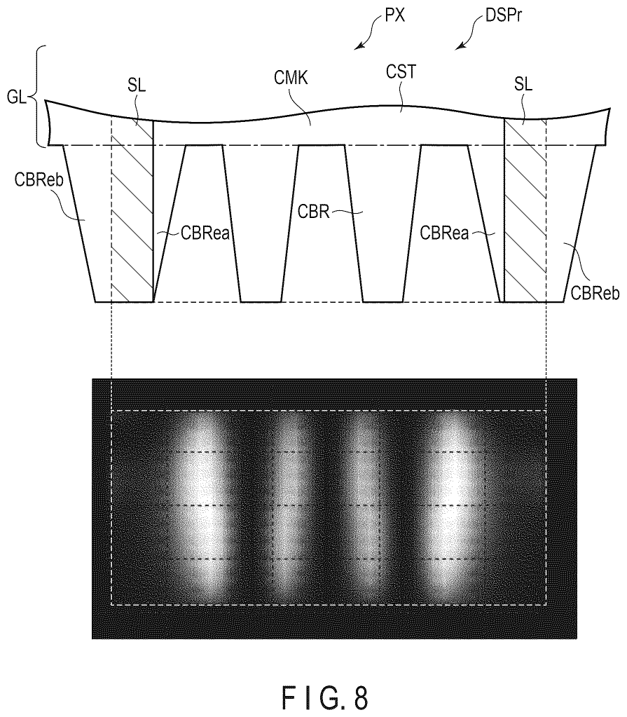

FIGS. 7 and 8 are diagram each showing the relationship between the branch portion of the slit and the light transmission in the comparison example. FIG. 7 is a plan view showing the case where branch portions are not provided near the signal lines SL, which is a diagram showing light transmission thereof. FIG. 8 is a plan view showing the case where branch portions are provided near the signal lines SL, which is a diagram showing light transmission thereof. In FIG. 8, the region of the branch portion CBR located near the signal line SL in one single pixel PX is defined as a region CBRea. The region of the branch portion CBR, which opposes the region CBRea while interposing the signal line SL therebetween and arranged in a neighboring pixel PX is referred to as a region CBReb. The total area of the region CBRea and the region CBReb is equal to the area of a single branch portion CBR.

When comparing FIGS. 7 and 8 with each other, it can be understood that there is more light transmission when a branch portion CBR is not located near the signal line SL (FIG. 7) than the case where a branch portion CBR is located near the signal line SL (FIG. 8). That is, the pixel PX shown in FIG. 7 is brighter than the pixel PX shown in FIG. 8. This is considered to be because the pitch of the branch portion CBR changes in the slit CST shown in FIG. 8, which causes an effect on the alignment of the liquid crystals in the slit CST.

However, if the branch portion CBR is not provided, it is difficult to control the liquid crystal molecules LCM located near the signal line SL, and the liquid crystal molecules LCM can easily rotate. Further, at the boundary between adjacent pixels PX, the branch portion CBR is not provided so as to interpose the signal line SL between these pixels. Therefore, the pitch of the region where the liquid crystal molecules LCM do not rotate becomes longer, and the rotation of the liquid crystal molecules LCM slows down.

If the rotation speed of the liquid crystal molecules LCM near the signal line SL slows down, a difference in rotation speed will occur between the liquid crystal molecules LCM that rotate near the edge ED1 of the branch portion CBR and those that rotate near the edge ED2. As a result, a difference in brightness/darkness may occur in the region near the signal line SL and the regions near the edge ED1 and edge ED2.

In this embodiment, a part of the signal line SL is extended to shield the region where the rotation of the liquid crystal molecules LCM slows down. As a result, the luminance within the pixel PX is made uniform, and the response speed is made high and uniform.

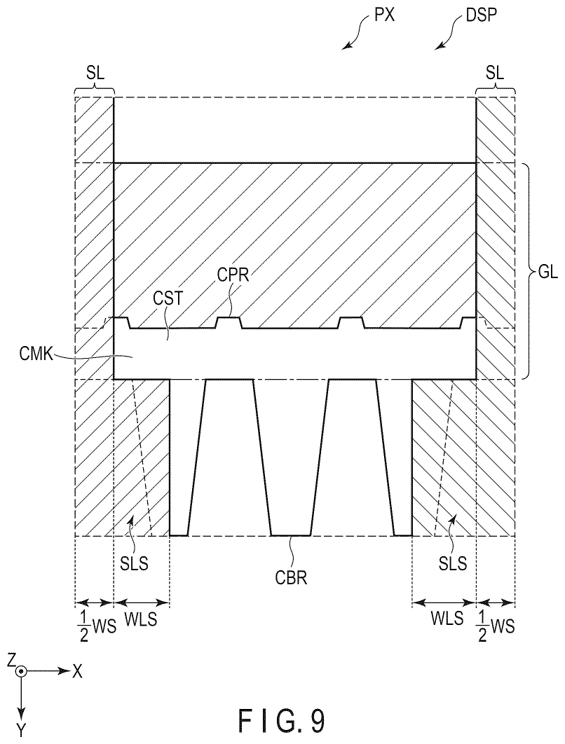

FIG. 9 is a plan view showing the configuration of the pixel of the embodiment. The display device DSP shown in FIG. 9 differs from the display device DSPr shown in FIG. 4 in that a part of the signal line SL functions as a light-shielding layer.

In FIG. 9, for example, a part of the signal line SL on the right side of the page extends along the opposite direction of the first direction X, and covers half of the branch portion CBR located closest to the respective signal line SL. The region that covers half of the branch portion CBR is referred to as a region SLS. The region SLS is formed into a rectangular shape. The length (width) of the region SLS along the direction parallel to the first direction X is defined as a width WLS.

Here, similarly, for example, the region SLS, which is a part of the signal line SL on the left side of the page, extends along the first direction X and covers half of the branch portion CBR located closest to the signal line SL.

When the branch portion CBR of the slit CST is not provided near the signal line SL, a pixel PX having high luminance can be achieved. Furthermore, when the light-shielding region SLS is provided near the signal line SL, the region where the liquid crystal molecules LCM rotate at low speed can be shielded, and therefore it is possible to suppress the occurrence of differences in brightness/darkness and differences in the rotation speed of the liquid crystal molecules LCM within the pixel PX. As described so far, it is possible to obtain a pixel having high luminance, uniform and high luminance within the pixel, and high response speed.

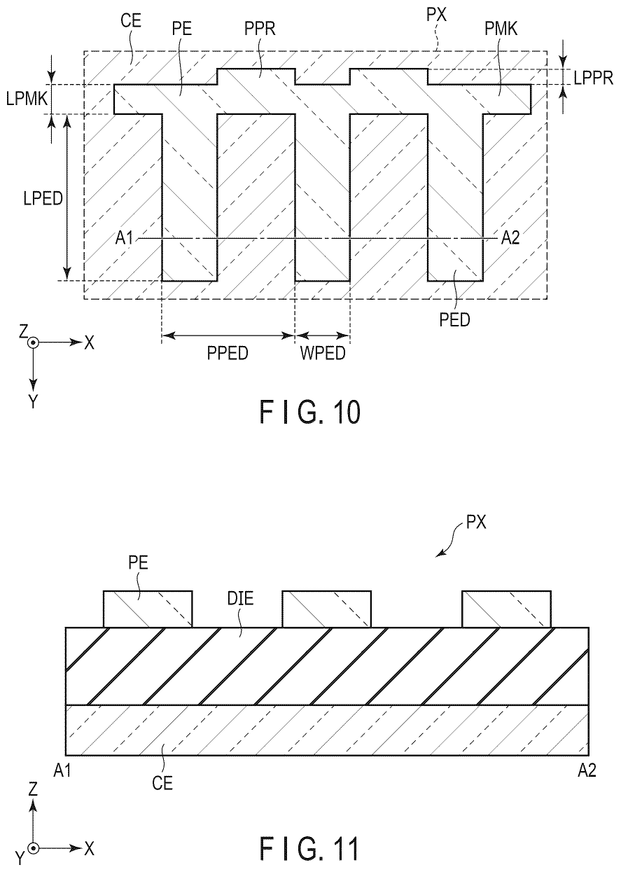

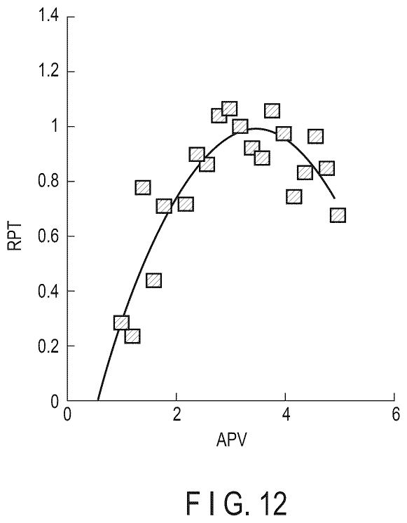

FIG. 10 is a plan view showing the pixel electrode and common electrode of the pixel. FIG. 11 is a cross-sectional view showing a cross-sectional structure of the pixel shown in FIG. 10, taken along line A1-A2. FIG. 12 is a diagram indicating the response speed of the pixel in response to the voltage applied. In other words, FIG. 12 is a graph plotting the response speed of the pixel PX for the pixel PX shown in FIGS. 10 and 11.

In the pixel PX shown in FIG. 10, the pixel electrode PE has a trunk portion PMK that extends along a direction parallel to the first direction X, a protrusion portion PPR that protrudes from the trunk portion PMK in the opposite direction of the second direction Y, and a branch portion PED that extends from the trunk portion PMK along the second direction Y. The protrusion portion PPR and the branch portion PED each have a rectangular shape.

The length (width) of the trunk portion PMK along the second direction Y is defined as a length LPMK. The length of the protrusion portion PPR along the second direction Y is defined as a length LPPR. The length of the branch portion PED along the second direction Y is defined as a length LPED. The length (width) of one branch portion PED along the first direction X is defined as a width WPED. The pitch at which a plurality of branch portions PED are arranged along the first direction X is defined as a pitch PPED.

In the example shown in FIG. 10, the length LPMK is, for example, 1.0 μm. The length LPPR is, for example, 1.0 μm. The length LPED is, for example, 4.5 μm. The width WPED is, for example, 1.5 μm. The pitch PPED is, for example, 4.0 μm.

In the pixel PX shown in FIG. 11, the pixel electrodes PE are provided above the common electrode CE with the insulating layer DIE interposed therebetween. The common electrode CE and the pixel electrodes PE are formed of a transparent conductive material, more specifically, indium tin oxide. The insulating layer DIE is formed of, for example, an inorganic insulating material, more specifically, silicon nitride.

FIG. 12 is a diagram showing the relationship between the applied voltage and the response speed in the pixel PX shown in FIGS. 10 and 11. In FIG. 12, the horizontal axis indicates the applied voltage APV [V], and the vertical axis indicates the response speed RPT [ms]. For the pixel PX shown in FIG. 12, when the temperature of the pixel PX is 25° C., the response speed RPT is 0.9 ms or more.

Therefore, if the pixel PX shown in FIG. 9 is formed based on the pixel PX shown in FIGS. 10 to 12, the pixel PX shown in FIG. 9 will also have a response speed of 0.9 ms or more. Thus, according to this embodiment, it is possible to obtain a display device DSP comprising pixels PX having high and uniform luminance and high response speed.

In the embodiment, for example, the configuration of the light shielding region SLS is not limited to that of the embodiment using the signal lines SL, but may be formed so that the scanning lines GL extend along the branch portion CBR of the slit CST, or may be formed using another metal layer formed in a layer different from that of the scanning lines GL and the signal lines SL. Without going into further detail, it is also possible to form a black matrix on the substrate SUB2 and to form a light shielding layer SLS using a black resin such as a black matrix on the substrate SUB1 side or the substrate SUB2 side.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a plurality of scanning lines extending along a first direction;
a plurality of signal lines extending along a second direction intersecting the first direction;
a plurality of pixels each provided at each respective one of intersections between the plurality of signal lines and the plurality of scanning lines; and
a common electrode including a slit including a trunk portion and a plurality of branch portions,
wherein
the plurality of pixels have a shape of a square, which has a same length along the first direction and the second direction,
the trunk portion extends along the first direction,
each of the plurality of branch portions extends from the trunk portion along the second direction,
a part of the signal lines extends along the first direction,
of the plurality of branch portions, those located close to the signal lines are shielded by a light shielding region, which is the part of the signal lines, and
the plurality of pixels are driven by a field sequential method.

2. The display device according to claim 1 further comprising:
a plurality of protrusion portions that extend in a direction opposite to a direction in which the branch portions extend from the trunk portion.

3. The display device according to claim 1, wherein
each of the plurality of branch portions has a trapezoidal shape in which an upper side is longer than a lower side.

4. The display device according to claim 2, wherein
each of the plurality of protrusion portions has a trapezoidal shape in which a lower side is longer than an upper side.

5. The display device according to claim 1, wherein
the light shielding region is rectangular in shape.
